(19) United States
(12) Patent Application Publication
(10) Pub. No.: US 2023/0064822 A1
(43) Pub. Date: Mar. 2, 2023

(54) TEMPERATURE CONTROLLED MEDIA MANAGEMENT OPERATIONS AT A MEMORY SUB-SYSTEM

(71) Applicant: Micron Technology, Inc., Boise, ID (US)

(72) Inventors: Douglas Trujillo, Folsom, CA (US); Kim Shane Webber, Boise, ID (US); Hongyu Wang, Folsom, CA (US)

(21) Appl. No.: 17/446,659

(22) Filed: Sep. 1, 2021

(51) Int. Cl. G06F 3/06; G01K 3/00

(52) U.S. Cl. CPC G06F 3/0659; G06F 3/0604; G06F 3/0653; G06F 3/0673; G01K 3/005

(57) ABSTRACT

A temperature of the memory device is determined. Whether the temperature satisfies a temperature criterion of a plurality of temperature criterions is determined. Responsive to determining that the temperature satisfies the temperature criterion, a media management operation and a mode of performing the media management operation is selected. The selected media management operation according to the selected mode is performed.

### TECHNICAL FIELD

Embodiments of the disclosure relate generally to memory sub-systems, and more specifically, relate to temperature controlled media management operations at a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates a look-up table to determine a mode of a media management operation for a memory device, in accordance with some embodiments of the present disclosure.

FIG. 3 is a flow diagram of an example method of selecting a mode to perform a media management operation, in accordance with some embodiments of the present disclosure.

FIG. 4 is a flow diagram of another example method of selecting a mode to perform a media management operation, in accordance with some embodiments of the present disclosure.

FIG. 5 is a block diagram of an example computer system in which embodiments of the present disclosure may operate.

### DETAILED DESCRIPTION

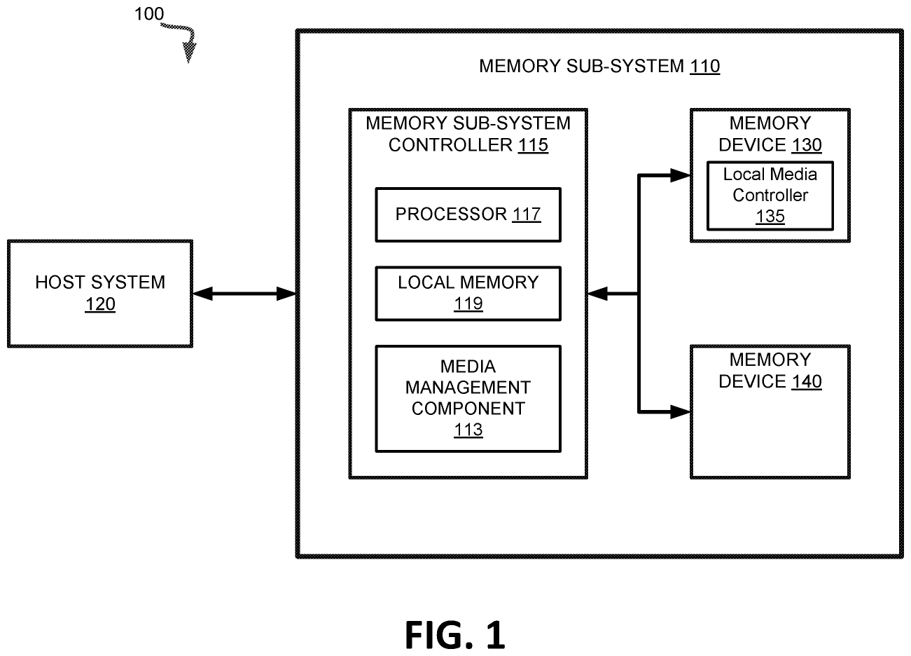

Aspects of the present disclosure are directed to temperature controlled media management operations at a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

In operation, memory devices may exhibit various phenomena, such as read disturbs and refresh drifts, which reduce the media endurance. A memory sub-system can perform media management operations (e.g., on-demand scrub, write refresh, read disturb, or write disturb) to mitigate against these challenges in the operation of the memory sub-system. For example, on-demand scrub (ODS) can be performed for mitigating read disturbs at the cost of increased write amplification and reduced performance. On-demand scrub, however, can be inefficient at high temperatures, at which write disturb can be a more suitable solution.

Accordingly, while media management operations can extend the endurance of memory devices, in some instances, same operations, depending on environmental conditions (e.g., temperature), may cause read and write amplification (i.e., increased number of reads and writes on the memory device) and/or degraded performance of the memory device without the intended benefit of extending endurance of the memory device.

Aspects of the present disclosure address the above and other deficiencies by having a memory sub-system that enables a controller to incorporate temperature to determine when and how to perform a media management operation. In some embodiments, media management operations can be performed at various frequencies (i.e., the rate at which the media management operations is performed) (e.g., low frequency, medium frequency, or high frequency). In some embodiments, whether to perform the media management operation may be based on whether the media management operations is enabled or disabled. Accordingly, each media management operation may include a plurality of modes (e.g., means to perform the media management operation) each associated with, for example, the frequency at which the media management operation is performed (e.g., low frequency, medium frequency, or high frequency) and/or whether to perform the media management operation (e.g., enabled or disabled). For example, a mode may be selected for performing a certain media management operation, e.g., according to the temperature measured at the memory device, Accordingly, the memory sub-system controller can determine when and how to perform media management operations at the memory device.

Advantages of the present disclosure include, but are not limited to, reducing the amount of read and/or write and maximizing performance of the memory device by minimizing performance degradation caused by inefficient and unnecessary media management operations.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes media management component 113 that manages the performance of media management operations for memory devices 130, 140 during operation of memory sub-system 110. In some embodiments, the memory sub-system controller 115 includes at least a portion of the media management component 113. In some embodiments, the media management component 113 is part of the host system 120, an application, or an operating system. In other embodiments, local media controller 135 includes at least a portion of media management component 113 and is configured to perform the functionality described herein.

The media management component 113 can facilitate performing media management operations on memory devices 130, 140. A media management operation can be e.g., an on-demand scrub, a write refresh, a read disturb, or a write disturb. Although some embodiments of the present disclosure are described with respect to, for example, on-demand scrub, aspects of this disclosure can be applied to performing other media management operations (e.g., read disturb, write disturb, write refresh, garbage collection operation, folding operation, wear leveling, etc.). Media management component 113 can determine whether a media management operation should be performed on a data unit and/or a memory device. The media management component 113, can identify one or more media managements to be performed on the memory device 130. Identifying one or more media management operations to perform may be based on a predetermined time period, a media management operation criteria being satisfied, or etc. For example, a media management operation based on a predetermined time may be a media management operation set to be performed every predetermined time period (e.g., every X cycle count) for an intended benefit, such as, increasing endurance of the memory device. When the predetermined time period has been reached, the media management operation to be performed is the identified media management. For example, a media management operation based on a media management operation criteria may be a media management operation (e.g., on-demand scrub) that is performed if and only if the media management operation criteria (e.g., error prevention process or error recovery operation) is satisfied. Accordingly, once the media management criteria is satisfied the media management operation to be performed is the identified media management operation.

The media management component 113 may determine the temperature of the memory device 130. For each media management operation to be performed, the media management component 113 can select, based on the temperature of the memory device, a mode of performing the media management operation (e.g., enable or disable the media management operation, and/or perform the media management operation at low frequency, medium frequency, and high frequency). For example, if the selected mode of the media management operation is to disable the media management operation, the media management component 113 does not perform the media management operation due to the temperature of the memory devices 130, 140. If the selected mode of the media management operation is to enable the media management operation, the media management component 113 performs the media management operation. If the selected mode associated with the media management operation is low, medium, or high frequency, the media management component 113, performs the media management operation less frequently to more frequently, based on the selected mode. To select one of a low frequency, a medium frequency, or a high frequency, the media management component 113 matches the determined temperature of the memory device 130 with a predefined temperature threshold or temperature range associated with each frequency (e.g., low frequency, medium frequency, and high frequency). In some embodiments where the frequency has a corresponding temperature range, the media management component 113 would set the frequency based on determining that the determined temperature of the memory device 130 falls within the temperature range. In some embodiments where the frequency has a corresponding temperature threshold, the media management component 113 would set the frequency based on determining that the determined temperature is equal to or less than the temperature threshold. Further details with regards to the operations of the media management component 113 are described below.

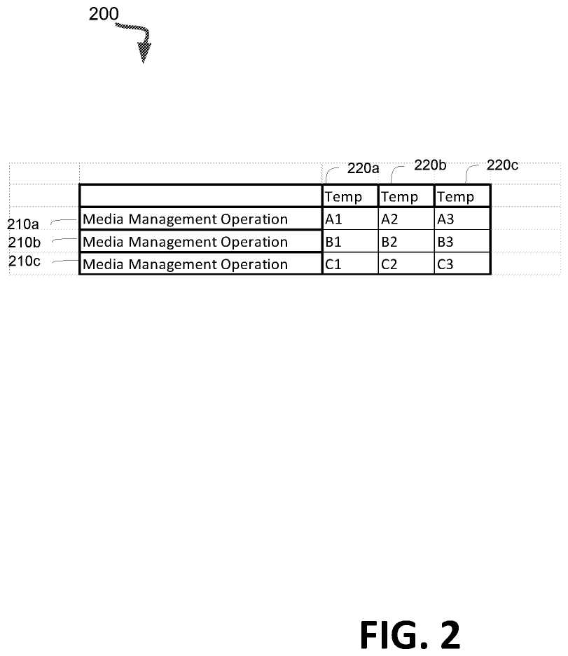

FIG. 2 illustrates a look-up table 200 to select a mode of performing a given media management operation for a memory device, in accordance with some embodiments of the present disclosure. The look-up table 200 may be stored in the local memory 119 of the memory sub-system 110. Look-up table 200 includes multiple entries 210A-210C, such that each entry corresponds to a media management operation. Each entry 210a-210c includes a set of media operation modes corresponding to specified temperatures 220A-220C. The specified temperature 220A-220C is one of a temperature threshold (e.g., 50° C.) or a temperature range (e.g., 25° C.-50° C.).

Depending on the embodiment, the specified temperature 220A-220C for each media management operation mode is determined based the effects of the respective media management operation at a designated temperature. For example, the look-up table 220 may be populated based on a list of temperatures in which the media management operation can be performed optimally (e.g., produces the desired results in the memory device) and a list of temperatures in which the media management operations may causes unnecessary degradation to the memory device (e.g., degradation to the performance and/or endurance without the desired result in the memory device).

Depending on the embodiment, for example, a mode of enable is assigned to the list of temperatures in which the media management operation is performed optimally, and a mode of disable is assigned to the list temperatures in which the media management operation causes degradation to the memory device. In some embodiments, rather than assigning each temperature of the list of temperatures to a mode, the list of temperatures may be consolidated into a range of temperature.

Depending on the embodiment, for example, if as the temperature increases or decreases the degradation of the memory device increases (e.g., degradation in performance or endurance), each grouping of the list of temperatures may be assigned to a frequency mode. That is, if as the temperature increases, degradation increases, it may be beneficial to reduce the frequency of the media management operation. Therefore, the first grouping of temperature may be assigned to a high frequency mode, the second grouping of temperature may be assigned to medium frequency mode, and the third grouping of temperature may be assigned to low frequency mode.

The modes (e.g., low frequency, medium frequency, and high frequency) determines how the media management operation is to be performed on the memory device. For example, with a memory device having a temperature 220a in which media management operation 210a is to be performed on the memory device, mode A1 (e.g., low frequency) of media management operation 210a is selected. In another example, with a memory device having a temperature 220b in which media management operation 210a is to be performed on the memory device, mode A2 (e.g., medium frequency) of media management operation 210a is selected. In yet another example, with a memory device having a temperature 220c in which media management operation 210a is to be performed on the memory device, mode A3 (e.g., high frequency) of media management operation 210a is selected.

In some embodiments, the mode (e.g., enable or disable) determines whether to perform the media management operation on the memory device by enabling or disabling the media management operation. For example, with a memory device having a temperature 220a in which media management operation 210a is to be performed on the memory device, mode A1 (e.g., enable) of media management operation 210a is selected. In another example, with a memory device having a temperature 220b in which media management operation 210a is to be performed on the memory device, mode A2 (e.g., enable) of media management operation 210a is selected. In yet another example, with a memory device having a temperature 220c in which media management operation 210a is to be performed on the memory device, mode A3 (e.g., disable) of media management operation 210a is selected.

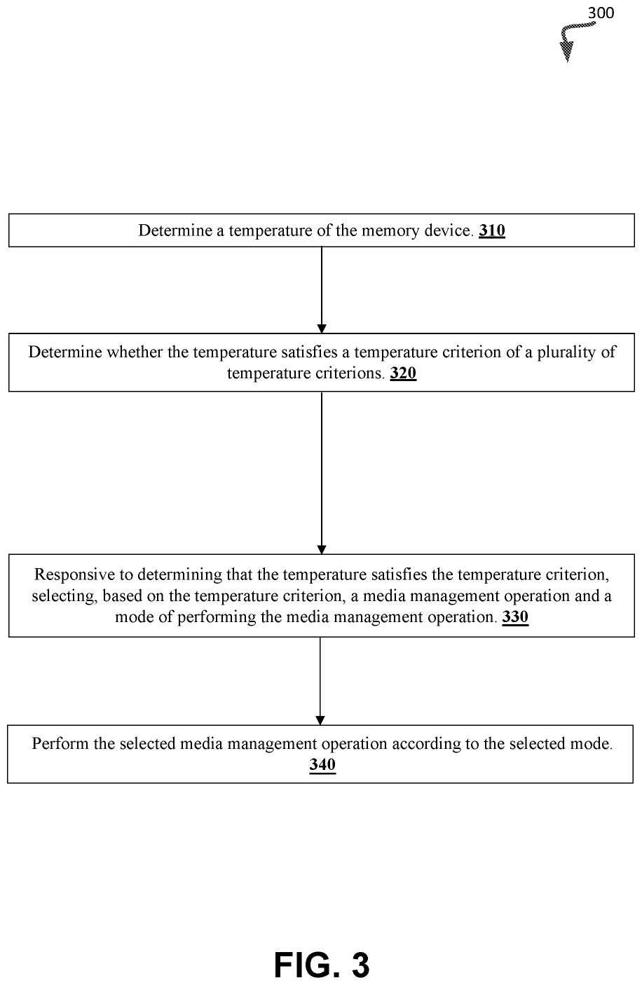

FIG. 3 is a flow diagram of an example method 300 to select a mode to perform a media management operation, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the media management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic determines a temperature of the memory device. In some embodiments, prior to, during or subsequent to determining the temperature of the memory device, the processing logic determines which media management operation is to be performed on the memory device. As described previously, the media management operations can include one of: an on-demand scrub, a write refresh, a read disturb, or a write disturb. Depending on the embodiment, determining the media management operation that is to be performed on the memory device, the processing logic determines whether an error recovery process was successful. Based on a successful error recovery process (e.g. preset sequence of read retry operations), the processing logic, determines the media management operations (e.g., an on-demand scrub) that is to be performed on the memory device. In some embodiments, the processing logic determines which media management operation to be performed based on a predetermined time period. Depending on the embodiment, each media management operation is to be performed every predetermined time period, therefore, the processing logic based on the media management associated with the predetermined time period the media management operation is determined.

At operation 320, the processing logic determines whether the temperature satisfies a temperature criterion of a plurality of temperature criterions. Each temperature criterion of the plurality of temperature criterion is specified either a respective threshold temperature (e.g., 0° C., 45° C., 85° C.) or a respective threshold temperature range (e.g., between 0° C. and 45° C. between 45° C. and 75° C., or greater than 85° C.).

At operation 330, responsive to determining that the temperature satisfies the temperature criterion, the processing logic selects, based on the temperature criterion, a mode of a plurality of modes of a media management operation to perform the media management operation. Depending on the embodiment, the plurality of modes associated with media management operations, such as, on-demand scrub, read disturb, and write disturb includes enable and disable. As described previously, if the mode of the plurality of modes is enable, the processing logic performs the media management operation. Otherwise, if the mode of the plurality of modes is disable, the processing logic does not perform the media management operation. In some embodiments, the plurality of modes associated with media management operations, such as, write refresh includes a low frequency, a medium frequency, and a high frequency. As described previously, the processing logic performs the media management operation at a frequency consistent with the selected mode. For example, if the mode is low frequency, the processing logic performs the media management operations is performed less frequently. If the mode is high frequency, the processing logic performs the media management operation more frequently.

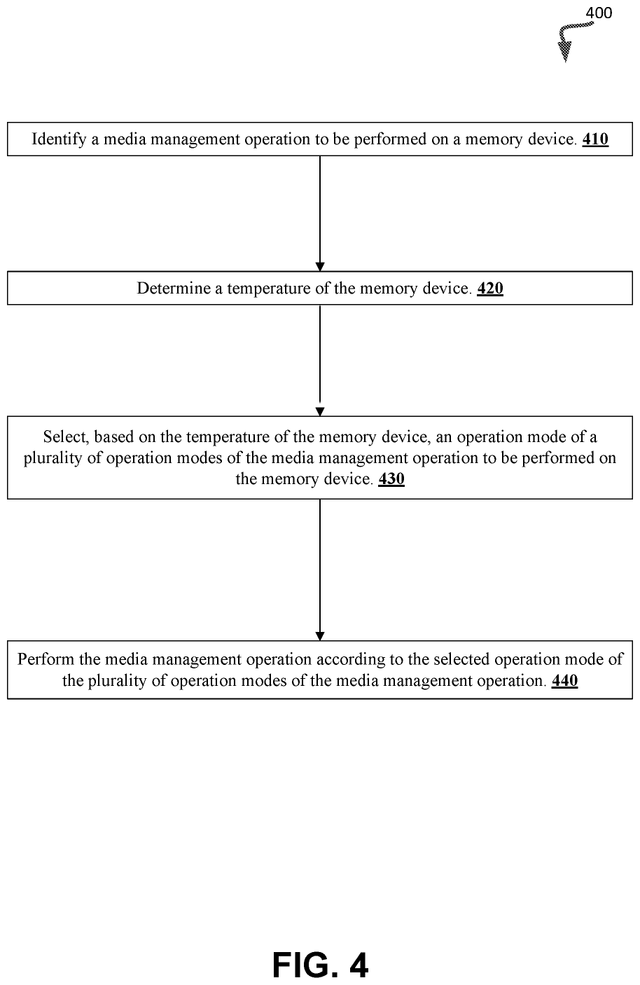

FIG. 4 is a flow diagram of an example method 400 to select a mode to perform a media management operation, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the media management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic identifies a media management operation to be performed on a memory device. As described previously, the media management operations can include one of: an on-demand scrub, a write refresh, a read disturb, or a write disturb. At operation 420, the processing logic determines a temperature of the memory device.

At operation 430, the processing logic selects, based on the temperature of the memory device, an operation mode of a plurality of operation modes of the media management operation to be performed on the memory device. Each operation mode of the plurality of operation modes is associated with a temperature at which the operation mode of the plurality of operation modes is selected for the media management operation to be performed on the memory device. The temperature may be a specific temperature (e.g., 0° C., 45° C., 85° C.) or a temperature range (e.g., between 0° C. and 45° C. between 45° C. and 75° C., or greater than 85° C.). The plurality of operation modes includes enable, disable, low frequency, medium frequency, and high frequency.

At operations 440, the processing logic performs the media management operation according to the selected operation mode of the plurality of operation modes of the media management operation.

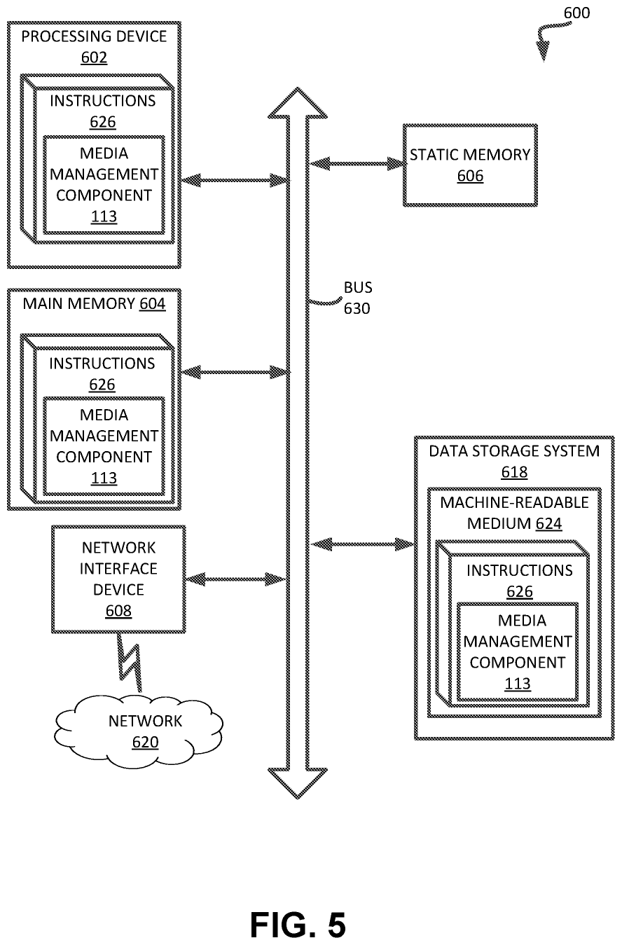

FIG. 5 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a media management component (e.g., the media management component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device coupled to the memory device, the processing device to perform operations comprising:
determining a temperature of the memory device;
determining whether the temperature satisfies a temperature criterion of a plurality of temperature criterions;
responsive to determining that the temperature satisfies the temperature criterion, selecting, based on the temperature criterion, a media management operation and a mode of performing the media management operation; and
performing the selected media management operation according to the selected mode.

2. The system of claim 1, wherein each temperature criterion of the plurality of temperature criterion is specified by one of: a respective threshold temperature or a respective temperature range.

3. The system of claim 1, wherein the media management operation is one of: an on-demand scrub, a write refresh, a read disturb, or a write disturb.

4. The system of claim 1, wherein the mode of performing the media management operation is represented by one of: enable or disable.

5. The system of claim 1, wherein the mode of performing the media management operation is represented by one of: low frequency, medium frequency, or high frequency.

6. The system of claim 1, wherein performing the selected media management according to the selected mode includes determining whether to perform the media management operation based on one of: media management criteria or a predetermined time period.

7. The system of claim 6, wherein the media management criteria is an error recovery process.

8. The system of claim 7, wherein the error recover operation comprises a predefined sequence of read retry operations.

9. A method comprising:
determining a temperature of a memory device;
determining whether the temperature satisfies a temperature criterion of a plurality of temperature criterions; and
responsive to determining that the temperature satisfies the temperature criterion, selecting, based on the temperature criterion, a media management operation and a mode of performing the media management operation; and
performing the selected media management according to the selected mode.

10. The method of claim 9, wherein each temperature criterion of the plurality of temperature criterion is specified by one of: a respective threshold temperature or a respective temperature range.

11. The method of claim 9, wherein the media management operation is one of: an on-demand scrub, a write refresh, a read disturb, or a write disturb.

12. The method of claim 9, wherein the mode of performing the media management operation is represented by one of: enable or disable.

13. The method of claim 9, wherein the mode of performing the media management operation is represented by one of: low frequency, medium frequency, or high frequency.

14. The method of claim 9, wherein performing the selected media management according to the selected mode includes determining whether to perform the media management operation based on one of: media management criteria or a predetermined time period.

15. The method of claim 14, wherein the media management criteria is an error recovery process.

16. The method of claim 15, wherein the error recover operation comprises a predefined sequence of read retry operations.

17. A non-transitory computer-readable storage medium comprising instructions that, when executed by a processing device, cause the processing device to perform operations comprising:
identifying a media management operation to be performed on a memory device;
determining a temperature of the memory device;
selecting, based on the temperature of the memory device, an operation mode of a plurality of operation modes of the media management operation to be performed on the memory device;
performing the media management operation according to the selected operation mode of the plurality of operation modes of the media management operation.

18. The non-transitory computer-readable storage medium of claim 17, wherein each operation mode of the plurality of operation modes is associated with a temperature at which the operation mode of the plurality of operation modes is selected for the media management operation to be performed on the memory device.

19. The non-transitory computer-readable storage medium of claim 17, wherein the identified media management operation is one of: an on-demand scrub, a write refresh, a read disturb, or a write disturb.

20. The non-transitory computer-readable storage medium of claim 17, wherein the plurality of operation modes comprises enable, disable, low frequency, medium frequency, and high frequency.
